(19) United States
(12) Patent Application Publication
(10) Pub. No.: US 2026/0249872 A1
(43) Pub. Date: Aug. 27, 2026

(54) NOTIFICATION APPARATUS AND NOTIFICATION METHOD

(71) Applicant: TOYOTA JIDOSHA KABUSHIKI KAISHA, Toyota-shi (JP)

(72) Inventor: Kazuki FUKAZAWA, Toyota-shi (JP)

(73) Assignee: TOYOTA JIDOSHA KABUSHIKI KAISHA, Toyota-shi (JP)

(21) Appl. No.: 19/545,802

(22) Filed: Feb. 20, 2026

(30) Foreign Application Priority Data
Feb. 27, 2025 (JP) 2025-030123

(51) Int. Cl. B60W 50/14; G06V 20/58

(52) U.S. Cl. CPC B60W 50/14; G06V 20/58; B60W 2050/143; B60W 2050/146; B60W 2420/403; B60W 2554/801; B60W 2554/802

(57) ABSTRACT

The present disclosure provides a notification apparatus for suppressing discomfort and confusion of an occupant when a plurality of objects are simultaneously detected. The notification apparatus includes front, rear, and lateral object detection units and a control unit configured to execute notification processing when a detected object satisfies a notification condition. The control unit determines a traveling direction of an own vehicle and sets a traveling-direction region and an opposite-direction region. When the traveling direction is forward, a front object is treated as a traveling-direction object and rear and lateral objects are treated as opposite-direction objects, and when the traveling direction is rearward, a rear object is treated as the traveling-direction object and front and lateral objects are treated as opposite-direction objects. When both objects are detected, the control unit sets a priority based on a relative positional relationship and executes notification processing accordingly.

### CROSS-REFERENCE TO RELATED APPLICATION

This application claims priority to Japanese Patent Application No. JP2025-030123 filed on Feb. 27, 2025, the content of which is hereby incorporated by reference in its entirety into this application.

### BACKGROUND OF THE INVENTION

### 1. Field of the Invention

The present disclosure relates to a notification apparatus and a notification method, and more particularly to a technique for notifying an occupant of an own vehicle of a warning when an object in the surroundings approaches the own vehicle.

### 2. Description of the Related Art

For example, Japanese Patent Application Laid-Open (kokai) No. 2024-143293

discloses a technique in which, when a first object present within a predetermined distance range from an own vehicle and a second object approaching the own vehicle from outside the predetermined distance range are simultaneously detected, the presence of the object detected at a later timing among the first object and the second object is notified to a driver of the own vehicle.

In recent years, it has become possible to detect objects present not only in front of and behind an own vehicle but also on lateral sides of the own vehicle. Accordingly, it is assumed that a plurality of objects approaching the own vehicle can be simultaneously detected from multiple directions. In such a case, if multiple alarm sounds are output simultaneously, this may cause discomfort to occupants of the own vehicle or may lead to confusion of the occupants. Therefore, when a plurality of objects approaching from multiple directions are simultaneously detected, it is desirable to notify warnings in accordance with an appropriate priority order.

### SUMMARY OF THE INVENTION

The technique of the present disclosure has been made in view of the above circumstances, and an object thereof is to realize warning notification that can effectively suppress discomfort and confusion of occupants when a plurality of objects approaching from multiple directions are simultaneously detected.

A technique according to the present disclosure is a notification apparatus comprising:

a front object detection unit configured to detect a front object present within a predetermined range in front of an own vehicle;

a rear object detection unit configured to detect a rear object present within a predetermined range behind the own vehicle;

a lateral object detection unit configured to detect a lateral object present within predetermined ranges on left and right sides of the own vehicle; and

a control unit configured to execute notification processing for notifying a warning to an occupant of the own vehicle when an object detected by at least one of the front object detection unit, the rear object detection unit, and the lateral object detection unit satisfies a predetermined notification condition,

wherein the control unit is configured to:

set a predetermined region in a traveling direction of the own vehicle as a traveling-direction region and set a predetermined region other than the traveling-direction region around the own vehicle as an opposite-direction region;

when the traveling direction is forward, treat the front object detected by the front object detection unit as a traveling-direction object present in the traveling-direction region, and treat the rear object detected by the rear object detection unit and the lateral object detected by the lateral object detection unit as opposite-direction objects present in the opposite-direction region;

when the traveling direction is rearward, treat the rear object detected by the rear object detection unit as a traveling-direction object present in the traveling-direction region, and treat the front object detected by the front object detection unit and the lateral object detected by the lateral object detection unit as opposite-direction objects present in the opposite-direction region; and

when a specific condition in which both the traveling-direction object and the opposite-direction object are detected while the own vehicle is traveling is satisfied, set a priority based on a relative positional relationship between the traveling-direction object and the opposite-direction object with respect to the own vehicle and execute the notification processing targeting either the traveling-direction object or the opposite-direction object in accordance with the set priority.

### BRIEF DESCRIPTION OF THE DRAWINGS

FIG. 1 is a schematic diagram illustrating a hardware configuration of a vehicle according to the present embodiment.

FIG. 2 is a schematic diagram illustrating a software configuration of a control apparatus according to the present embodiment.

FIG. 3A is a schematic diagram illustrating specific examples of priority determination processing according to the present embodiment.

FIG. 3B is a schematic diagram illustrating specific examples of priority determination processing according to the present embodiment.

FIG. 4A is a schematic diagram illustrating specific examples of priority determination processing according to the present embodiment.

FIG. 4B is a schematic diagram illustrating specific examples of priority determination processing according to the present embodiment.

FIG. 5A is a schematic diagram illustrating specific examples of priority determination processing according to the present embodiment.

FIG. 5B is a schematic diagram illustrating specific examples of priority determination processing according to the present embodiment.

FIG. 6 is a flowchart illustrating a routine of priority determination processing and notification processing according to the present embodiment.

### DESCRIPTION OF THE EMBODIMENTS

Hereinafter, a notification apparatus and a notification method according to the present embodiment will be described with reference to the drawings.

### Hardware Configuration

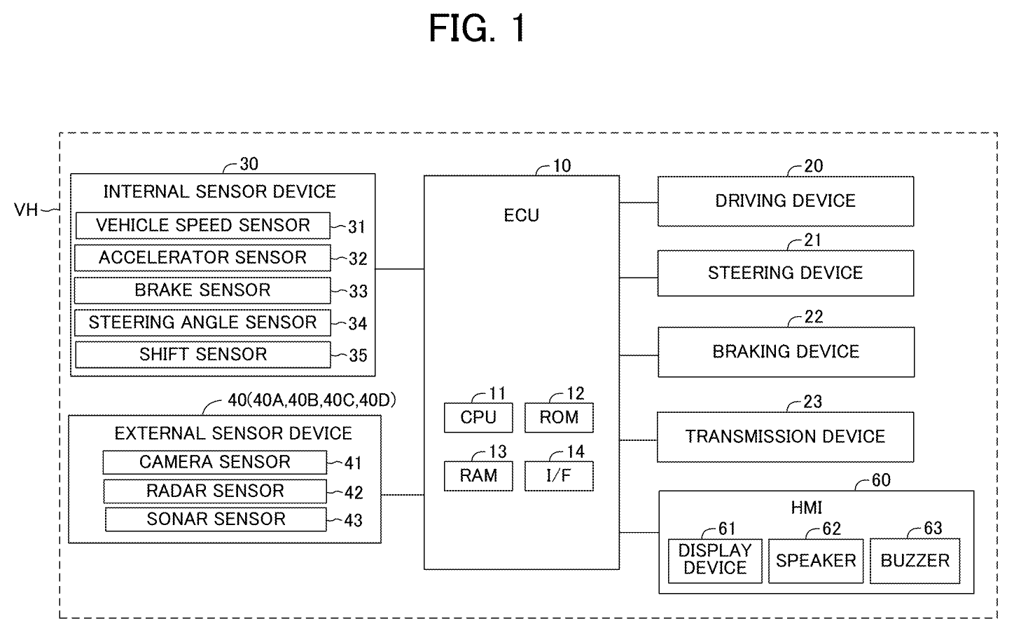

FIG. 1 is a schematic diagram illustrating a hardware configuration of a vehicle VH according to the present embodiment. In the following description, the vehicle VH may also be referred to as an “own vehicle” when it is necessary to distinguish the vehicle VH from other vehicles.

The vehicle VH includes an electronic control unit (ECU) 10. The ECU 10 includes a central processing unit (CPU) 11, a read-only memory (ROM) 12, a random access memory (RAM) 13, an interface device 14, and the like. The CPU 11 is a processor configured to execute various programs stored in the ROM 12. The ROM 12 is a nonvolatile memory that stores data and programs necessary for execution by the CPU 11. The RAM 13 is a volatile memory that provides a work area in which various programs are deployed when executed by the CPU 11. The interface device 14 is a communication device for communicating with external devices.

The ECU 10 serves as a central apparatus for performing driving assistance such as notification control. Driving assistance includes a concept encompassing automated driving. The ECU 10 is communicatively connected to a driving device 20, a steering device 21, a braking device 22, a transmission device 23, an in-vehicle sensor device 30, an external sensor device 40, a human machine interface (HMI) 60, and the like.

The driving device 20 generates a driving force to be transmitted to driving wheels of the vehicle VH, and may include, for example, an electric motor or an engine. The steering device 21 applies a steering force to wheels of the vehicle VH. The braking device 22 applies a braking force to the wheels of the vehicle VH. The transmission device 23 changes rotational power output from the driving device 20 at a predetermined gear ratio and transmits the changed power to the driving wheels.

The internal sensor device 30 includes sensors configured to detect states of the vehicle VH. The internal sensor device 30 includes, for example, a vehicle speed sensor 31, an accelerator sensor 32, a brake sensor 33, a steering angle sensor 34, and a shift sensor 35. The internal sensor device 30 repeatedly transmits vehicle state information detected by the sensors 31 to 35 to the ECU 10 at a predetermined cycle.

The vehicle speed sensor 31 detects a traveling speed of the vehicle VH (hereinafter referred to as vehicle speed). The accelerator sensor 32 detects an operation amount of an accelerator pedal (not illustrated) operated by a driver. The brake sensor 33 detects an operation amount of a brake pedal (not illustrated) operated by the driver. The steering angle sensor 34 detects a rotation angle of a steering wheel or a steering shaft (not illustrated), that is, a steering angle. The shift sensor 35 detects a shift position (parking P, reverse R, neutral N, drive D, etc.) of the transmission device 23.

The external sensor device 40 includes sensors configured to acquire object information regarding objects present in surroundings of the vehicle VH (hereinafter referred to as surrounding objects). The external sensor device 40 includes, for example, a camera sensor 41, a radar sensor 42, and a sonar sensor 43. Examples of the surrounding objects include moving objects such as other vehicles and pedestrians, and stationary objects such as walls and poles. The external sensor device 40 repeatedly transmits acquired object information of the surrounding objects to the ECU 10 at a predetermined cycle.

The camera sensor 41 is, for example, a stereo camera or a monocular camera, and may be a digital camera including an imaging element such as a CMOS or CCD. The camera sensor 41 captures images of surroundings of the vehicle VH, and acquires object information of surrounding objects by processing the captured image data. The object information includes information representing, for example, a type of the surrounding object, a relative distance between the vehicle VH and the surrounding object, and a relative speed between the vehicle VH and the surrounding object. The type of the surrounding object may be recognized by machine learning such as pattern matching.

In the present embodiment, the camera sensor 41 includes, for example, a front camera sensor, a rear camera sensor, a left-side camera sensor, and a right-side camera sensor. The front camera sensor detects surrounding objects present within a predetermined range in front of the vehicle VH. The rear camera sensor detects surrounding objects present within a predetermined range behind the vehicle VH. The left-side camera sensor detects surrounding objects present within a predetermined range on a left side of the vehicle VH. The right-side camera sensor detects surrounding objects present within a predetermined range on a right side of the vehicle VH.

The radar sensor 42 includes a millimeter-wave radar and/or LiDAR. The millimeter-wave radar emits millimeter-wave radio waves and receives reflected waves reflected by surrounding objects present within an emission range. Based on a phase difference between transmitted and received waves, an attenuation level of the reflected waves, and a time from transmission to reception, the millimeter-wave radar acquires a relative distance and a relative speed between the vehicle VH and the surrounding objects. The LiDAR acquires information such as a shape of surrounding objects, and a relative distance and a relative speed between the vehicle VH and the surrounding objects by scanning pulse laser light having a wavelength shorter than that of millimeter waves in a plurality of directions and receiving reflected light.

In the present embodiment, the radar sensor 42 includes, for example, a front radar sensor, a rear radar sensor, a left-side radar sensor, and a right-side radar sensor. The front radar sensor detects surrounding objects present within a predetermined range in front of the vehicle VH. The rear radar sensor detects surrounding objects present within a predetermined range behind the vehicle VH. The left-side radar sensor detects surrounding objects present within a predetermined range on a left side of the vehicle VH. The right-side radar sensor detects surrounding objects present within a predetermined range on a right side of the vehicle VH.

The sonar sensor 43 emits ultrasonic waves to a predetermined range around the vehicle VH. The sonar sensor 43 receives reflected waves reflected by surrounding objects present within an emission range, and detects presence or absence of surrounding objects and a distance between the vehicle VH and the surrounding objects based on a time from transmission to reception. By emitting ultrasonic waves having high directivity, the sonar sensor 43 can detect surrounding objects located substantially in a front direction.

In the present embodiment, the sonar sensor 43 includes, for example, a front sonar sensor, a rear sonar sensor, a left-side sonar sensor, and a right-side sonar sensor. The front sonar sensor detects surrounding objects present within a predetermined range in front of the vehicle VH. The rear sonar sensor detects surrounding objects present within a predetermined range behind the vehicle VH. The left-side sonar sensor detects surrounding objects present within a predetermined range on a left side of the vehicle VH. The right-side sonar sensor detects surrounding objects present within a predetermined range on a right side of the vehicle VH.

In the following description, the front camera sensor, the front radar sensor, and the front sonar sensor are collectively referred to as a “front object detection sensor 40A.” The rear camera sensor, the rear radar sensor, and the rear sonar sensor are collectively referred to as a “rear object detection sensor 40B.” The left-side camera sensor, the left-side radar sensor, and the left-side sonar sensor are collectively referred to as a “left-side object detection sensor 40C.” The right-side camera sensor, the right-side radar sensor, and the right-side sonar sensor are collectively referred to as a “right-side object detection sensor 40D.”

The HMI 60 is an interface for inputting and outputting information between the ECU 10 and an occupant (mainly a driver) of the vehicle VH, and includes an input device and an output device. Examples of the input device include a touch panel, switches, and a voice input microphone. Examples of the output device include a display device 61, a speaker 62, and a buzzer 63. The display device 61 may be, for example, a center display installed in an instrument panel, a multi-information display, a head-up display, or a display of a navigation system. The speaker 62 may be, for example, a speaker of an audio system or a navigation system.

### Software Configuration

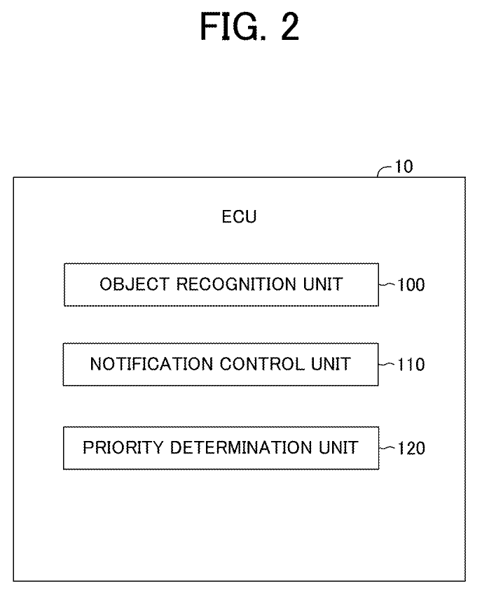

FIG. 2 is a schematic diagram illustrating a software configuration of the ECU 10 according to the present embodiment. As illustrated in FIG. 2, the ECU 10 functionally includes an object recognition unit 100, a notification control unit 110, and a priority determination unit 120. These functional units 100 to 120 are implemented by the CPU 11 of the ECU 10 reading programs stored in the ROM 12 into the RAM 13 and executing the programs. Some or all of the functional units 100 to 120 may alternatively be provided in another ECU separate from the ECU 10, or in an information processing apparatus of a facility (e.g., a management center) communicable with the vehicle VH.

The object recognition unit 100 recognizes surrounding objects present around the vehicle VH based on detection results of the external sensor device 40. For example, the object recognition unit 100 recognizes a relative distance between the vehicle VH and each surrounding object and a direction of the surrounding object relative to the vehicle VH. The object recognition unit 100 repeatedly transmits recognition results of the surrounding objects (such as relative distance and direction) to the notification control unit 110 at a predetermined cycle.

In the following description, rightward and leftward directions of the vehicle VH are referred to as “lateral directions” or “side directions.” Surrounding objects recognized by the object recognition unit 100 based on detection results of the front object detection sensor 40A are referred to as “front objects.” Surrounding objects recognized based on detection results of the rear object detection sensor 40B are referred to as “rear objects.” Surrounding objects recognized based on detection results of the left-side object detection sensor 40C or the right-side object detection sensor 40D are referred to as “lateral objects.”

When the vehicle VH is traveling at a predetermined vehicle speed (for example, a low speed) and a surrounding object recognized by the object recognition unit 100 approaches the vehicle VH, the notification control unit 110 executes notification processing to notify a warning to an occupant (for example, a driver) of the vehicle VH. The notification processing may be executed, for example, by outputting an alarm sound via the speaker 62 or the buzzer 63. The notification processing may also be executed in parallel with displaying a warning on the display device 61.

When a relative distance between a front object recognized based on detection results of the front object detection sensor 40A and the vehicle VH becomes equal to or less than a threshold distance while the vehicle VH is traveling, the notification control unit 110 executes notification processing for warning that the front object is approaching (hereinafter referred to as front notification processing). When a relative distance between a rear object recognized based on detection results of the rear object detection sensor 40B and the vehicle VH becomes equal to or less than the threshold distance while the vehicle VH is traveling, the notification control unit 110 executes notification processing for warning that the rear object is approaching (hereinafter referred to as rear notification processing). When a relative distance between a lateral object recognized based on detection results of the left-side object detection sensor 40C or the right-side object detection sensor 40D and the vehicle VH becomes equal to or less than the threshold distance while the vehicle VH is traveling, the notification control unit 110 executes notification processing for warning that the lateral object is approaching (hereinafter referred to as lateral notification processing).

When the object recognition unit 100 simultaneously recognizes a plurality of surrounding objects approaching the vehicle VH from multiple directions while the vehicle VH is traveling, if the notification control unit 110 executes notification processing for all of the surrounding objects, an increase in alarm sounds or unnecessary switching of alarm sounds may occur. As a result, a driver may feel annoyed or confused. Therefore, when a plurality of surrounding objects approaching from multiple directions are simultaneously recognized, it is desirable to output alarm sounds in accordance with priorities of notification processing. Hereinafter, details of the priority determination unit 120, which sets priorities of notification processing, will be described.

While the vehicle VH is traveling, the priority determination unit 120 determines a traveling direction of the vehicle VH. When the traveling direction is determined, the priority determination unit 120 sets a predetermined region in the traveling direction as a traveling-direction region and sets a predetermined region other than the traveling-direction region around the vehicle VH as an opposite-direction region. The traveling direction of the vehicle VH may be determined, for example, based on a detection result of the shift sensor 35. Specifically, when a shift position is Drive (D), the traveling direction may be determined as forward, and when the shift position is Reverse (R), the traveling direction may be determined as rearward. Alternatively, the traveling direction may be determined based on a rotation direction of wheels detected by the vehicle speed sensor 31 or based on changes in road surface images captured by the camera sensor 41.

When the traveling direction of the vehicle VH is determined to be forward, the priority determination unit 120 treats a front object recognized by the object recognition unit 100 based on detection results of the front object detection sensor 40A as a traveling-direction object OJ_{A} present in the traveling-direction region. In addition, when the vehicle VH travels forward, lateral directions are treated as rearward directions. Specifically, when the traveling direction is forward, the priority determination unit 120 treats a rear object recognized based on detection results of the rear object detection sensor 40B and a lateral object recognized based on detection results of the left-side object detection sensor 40C or the right-side object detection sensor 40D as opposite-direction objects OJ_{B} present in the opposite-direction region.

When the traveling direction of the vehicle VH is determined to be rearward, the priority determination unit 120 treats a rear object recognized by the object recognition unit 100 based on detection results of the rear object detection sensor 40B as a traveling-direction object OJ_{A} present in the traveling-direction region. In addition, when the vehicle VH travels rearward, lateral directions are treated as forward directions. Specifically, when the traveling direction is rearward, the priority determination unit 120 treats a front object recognized based on detection results of the front object detection sensor 40A and a lateral object recognized based on detection results of the left-side object detection sensor 40C or the right-side object detection sensor 40D as opposite-direction objects OJ_{B} present in the opposite-direction region.

When the object recognition unit 100 recognizes an opposite-direction object OJ_{B} while the notification control unit 110 is executing notification processing targeting a traveling-direction object OJ_{A}, the priority determination unit 120 compares degrees of risk between the traveling-direction object OJ_{A} and the opposite-direction object OJ_{B}. When a relative distance DR_{B} between the vehicle VH and the opposite-direction object OJ_{B} is less than or equal to a relative distance DR_{A} between the vehicle VH and the traveling-direction object OJ_{A} (DR_{B} ≤ DR_{A}), the priority determination unit 120 determines that the opposite-direction object OJ_{B} has a higher degree of risk than the traveling-direction object OJ_{A}. In this case, the priority determination unit 120 sets a higher priority for the opposite-direction object OJ_{B} than for the traveling-direction object OJ_{A}, and the notification control unit 110 prioritizes notification processing targeting the opposite-direction object OJ_{B} over notification processing targeting the traveling-direction object OJ_{A}.

Accordingly, a driver who has been paying attention to the traveling direction can recognize a new hazardous object approaching from a direction different from the traveling direction, thereby effectively improving safety. In addition, instead of outputting alarm sounds for both the traveling-direction object OJ_{A} and the opposite-direction object OJ_{B} simultaneously, prioritizing notification processing targeting the object determined to have the higher degree of risk can effectively suppress annoyance and confusion of the driver.

Similarly, when the object recognition unit 100 recognizes a traveling-direction object OJ_{A} while the notification control unit 110 is executing notification processing targeting an opposite-direction object OJ_{B}, the priority determination unit 120 compares degrees of risk between the traveling-direction object OJ_{A} and the opposite-direction object OJ_{B}. When a relative distance DR_{A} between the vehicle VH and the traveling-direction object OJ_{A} is less than or equal to a relative distance DRB between the vehicle VH and the opposite-direction object OJ_{B} (DR_{A} ≤ DR_{B}), the priority determination unit 120 determines that the traveling-direction object OJ_{A} has a higher degree of risk than the opposite-direction object OJ_{B}. In this case, the priority determination unit 120 sets a higher priority for the traveling-direction object OJ_{A} than for the opposite-direction object OJ_{B}.

Accordingly, a driver who has been paying attention to the opposite direction can recognize a new hazardous object approaching from a direction different from the opposite direction, thereby effectively improving safety. In addition, instead of outputting alarm sounds for both the opposite-direction object OJ_{B} and the traveling-direction object OJ_{A} simultaneously, prioritizing notification processing targeting the object determined to have the higher degree of risk can effectively suppress annoyance and confusion of the driver.

In the present disclosure, prioritizing notification processing includes not only outputting an alarm sound corresponding to an object having a higher priority, but also increasing a volume of the alarm sound corresponding to the object having the higher priority.

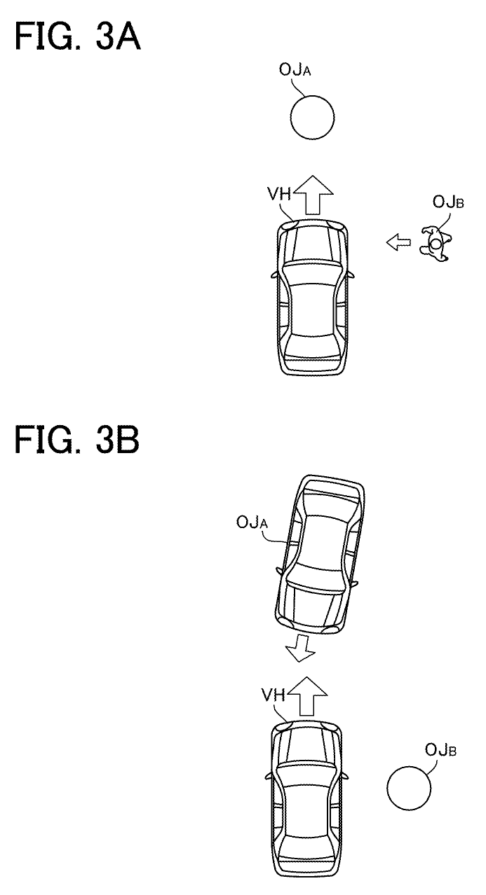

Specific examples of priority determination processing executed by the priority determination unit 120 will be described below with reference to FIGS. 3 to 5.

FIG. 3A illustrates an example in which the vehicle VH is traveling forward (shift position: Drive D), and while the notification control unit 110 is executing front notification processing targeting a front object (traveling-direction object OJ_{A}), the object recognition unit 100 recognizes a lateral object (opposite-direction object OJ_{B}) having a higher degree of risk than the front object. When the vehicle VH is traveling forward, the priority determination unit 120 treats lateral directions as rearward directions. In this case, the lateral object is a newly approaching object coming from a direction different from the front direction in which the front object is present. Therefore, when the lateral object has a higher degree of risk, the priority determination unit 120 sets a higher priority for the lateral object than for the front object, and notification processing targeting the lateral object is prioritized over notification processing targeting the front object.

Accordingly, a driver who has been paying attention to the front direction can recognize a newly occurring hazard in a lateral direction. In addition, instead of outputting alarm sounds for both objects simultaneously, prioritizing notification processing targeting the lateral object determined to have the higher degree of risk can effectively suppress annoyance and confusion of the driver.

FIG. 3B illustrates an example in which the vehicle VH is traveling forward (shift position: Drive D), and while the notification control unit 110 is executing lateral notification processing targeting a lateral object (opposite-direction object OJ_{B}), the object recognition unit 100 recognizes a front object (traveling-direction object OJ_{A}) having a higher degree of risk than the lateral object. When the vehicle VH is traveling forward, lateral directions are treated as rearward directions. In this case, the front object is a newly approaching object coming from a direction different from the lateral direction. Therefore, when the front object has a higher degree of risk, the priority determination unit 120 sets a higher priority for the front object than for the lateral object, and notification processing targeting the front object is prioritized over notification processing targeting the lateral object.

Accordingly, a driver who has been paying attention to a lateral direction can recognize a newly occurring hazard in the front direction. In addition, instead of outputting alarm sounds for both objects simultaneously, prioritizing notification processing targeting the front object determined to have the higher degree of risk can effectively suppress annoyance and confusion caused by an increase in alarm sounds.

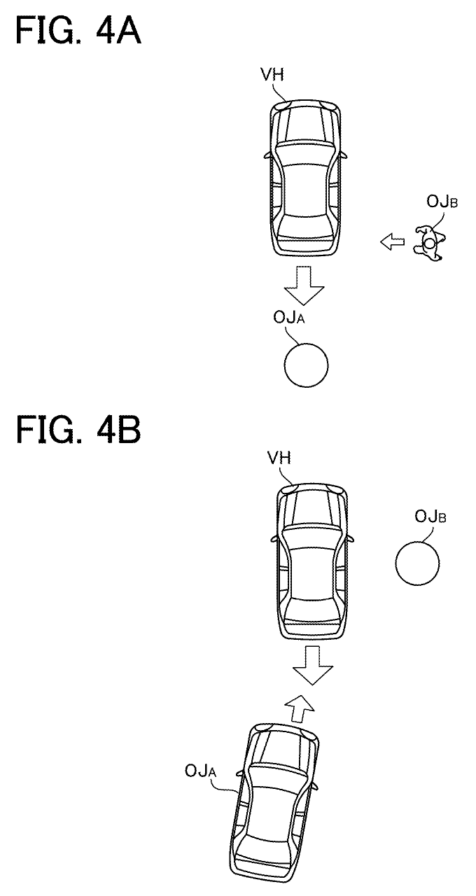

FIG. 4A illustrates an example in which the vehicle VH is traveling rearward (shift position: Reverse R), and while the notification control unit 110 is executing rear notification processing targeting a rear object (traveling-direction object OJ_{A}), the object recognition unit 100 recognizes a lateral object (opposite-direction object OJ_{B}) having a higher degree of risk than the rear object. When the vehicle VH is traveling rearward, the priority determination unit 120 treats lateral directions as forward directions. In this case, the lateral object is a newly approaching object coming from a direction different from the rear direction. Therefore, when the lateral object has a higher degree of risk, the priority determination unit 120 sets a higher priority for the lateral object than for the rear object, and notification processing targeting the lateral object is prioritized over notification processing targeting the rear object.

Accordingly, a driver who has been paying attention to the rear direction can recognize a newly occurring hazard in a lateral direction. In addition, instead of outputting alarm sounds for both objects simultaneously, prioritizing notification processing targeting the lateral object determined to have the higher degree of risk can effectively suppress annoyance and confusion of the driver.

FIG. 4B illustrates an example in which the vehicle VH is traveling rearward (shift position: Reverse R), and while the notification control unit 110 is executing lateral notification processing targeting a lateral object (opposite-direction object OJ_{B}), the object recognition unit 100 recognizes a rear object (traveling-direction object OJ_{A}) having a higher degree of risk than the lateral object. When the vehicle VH is traveling rearward, lateral directions are treated as forward directions. In this case, the rear object is a newly approaching object coming from a direction different from the lateral direction. Therefore, when the rear object has a higher degree of risk, the priority determination unit 120 sets a higher priority for the rear object than for the lateral object, and notification processing targeting the rear object is prioritized over notification processing targeting the lateral object.

Accordingly, a driver who has been paying attention to a lateral direction can recognize a newly occurring hazard in the rear direction. In addition, instead of outputting alarm sounds for both objects simultaneously, prioritizing notification processing targeting the rear object determined to have the higher degree of risk can effectively suppress annoyance and confusion caused by unnecessary switching of alarm sounds.

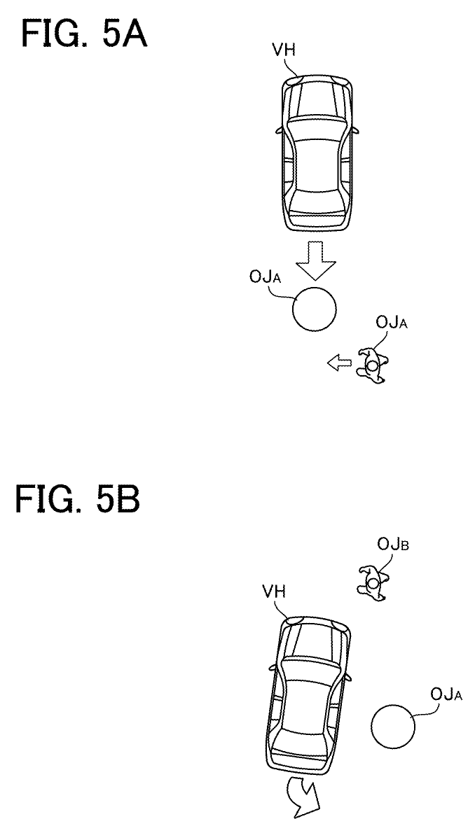

FIG. 5A illustrates an example in which the vehicle VH is traveling rearward (shift position: Reverse R), and while the notification control unit 110 is executing rear notification processing targeting a rear object (traveling-direction object OJ_{A}), the object recognition unit 100 recognizes a new rear object (traveling-direction object OJ_{A}). Since both objects approach from the same direction, when a degree of risk of the newly recognized rear object is equal to or lower than a degree of risk of the currently notified rear object, the priority determination unit 120 does not change the alarm sound. As a result, unnecessary switching of alarm sounds can be effectively suppressed.

FIG. 5B illustrates an example in which the vehicle VH is traveling rearward (shift position: Reverse R), and while the notification control unit 110 is executing lateral notification processing targeting a lateral object (opposite-direction object OJ_{B}), the object recognition unit 100 recognizes a new front object (opposite-direction object OJ_{B}). When the vehicle VH is traveling rearward, the priority determination unit 120 treats lateral directions as forward directions. In this case, both the currently notified lateral object and the newly recognized front object are located in directions different from the traveling direction. Since a driver is expected to pay sufficient attention to such regions during rearward traveling, when a degree of risk of the newly recognized front object is equal to or lower than a degree of risk of the currently notified lateral object, the priority determination unit 120 does not change the alarm sound. As a result, unnecessary switching of alarm sounds can be effectively suppressed.

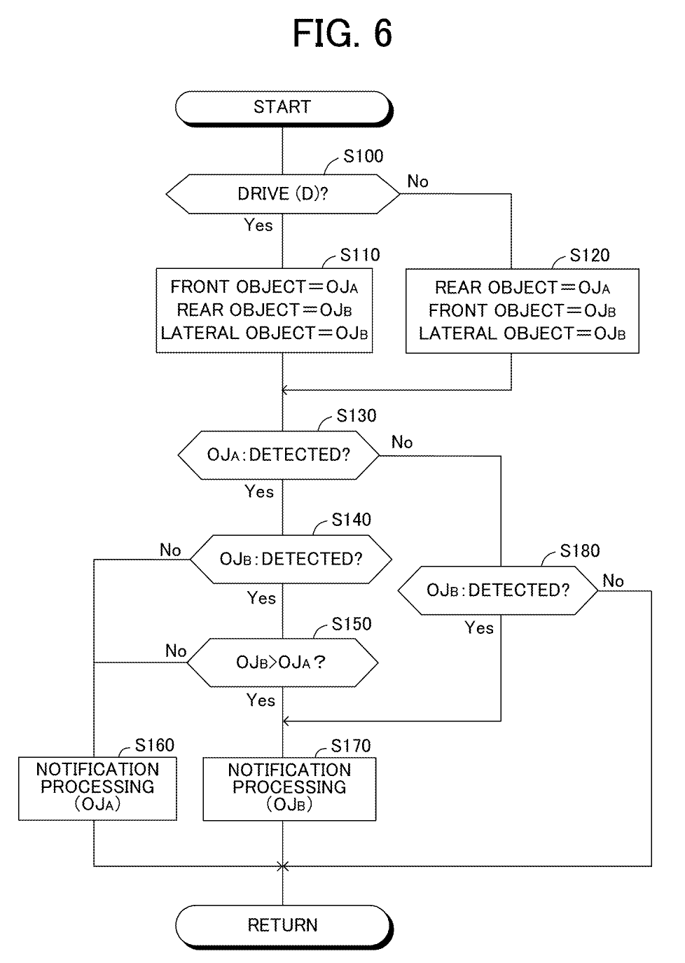

FIG. 6 is a flowchart illustrating a routine of priority determination processing and notification processing executed by the CPU 11 of the ECU 10. This routine is started, for example, when the vehicle VH begins traveling.

In step S100, the ECU 10 determines, based on a detection result of the shift sensor 35, whether a shift position is Drive (D), that is, whether a traveling direction of the vehicle VH is forward. When the shift position is Drive (D) (Yes), the ECU 10 proceeds to step S110. When the shift position is not Drive (D) (No), that is, when the traveling direction is determined to be rearward (shift position: Reverse R), the ECU 10 proceeds to step S120.

In step S110, the ECU 10 treats a front object recognized based on detection results of the front object detection sensor 40A as a traveling-direction object OJ_{A}. In addition, the ECU 10 treats a rear object recognized based on detection results of the rear object detection sensor 40B and a lateral object recognized based on detection results of the left-side object detection sensor 40C or the right-side object detection sensor 40D as opposite-direction objects OJ_{B}.

In step S120, the ECU 10 treats a rear object recognized based on detection results of the rear object detection sensor 40B as a traveling-direction object OJ_{A}. In addition, the ECU 10 treats a front object recognized based on detection results of the front object detection sensor 40A and a lateral object recognized based on detection results of the left-side object detection sensor 40C or the right-side object detection sensor 40D as opposite-direction objects OJ_{B}.

In step S130, the ECU 10 determines whether a traveling-direction object OJ_{A} to be subjected to notification processing is detected. When such a traveling-direction object OJ_{A} is detected (Yes), the ECU 10 proceeds to step S140. When such a traveling-direction object OJ_{A} is not detected (No), the ECU 10 proceeds to step S180.

In step S180, the ECU 10 determines whether an opposite-direction object OJ_{B} to be subjected to notification processing is detected. When such an opposite-direction object OJ_{B} is detected (Yes), that is, when only the opposite-direction object OJ_{B} is detected, the ECU 10 proceeds to step S170, executes notification processing targeting the opposite-direction object OJ_{B}, and then returns from the routine. When such an opposite-direction object OJ_{B} is not detected (No), that is, when neither the traveling-direction object OJ_{A} nor the opposite-direction object OJ_{B} is detected, the ECU 10 returns from the routine without executing notification processing.

When the ECU 10 proceeds from step S130 to step S140, the ECU 10 determines whether an opposite-direction object OJ_{B} to be subjected to notification processing is detected. When such an opposite-direction object OJ_{B} is detected (Yes), that is, when both the traveling-direction object OJ_{A} and the opposite-direction object OJ_{B} are detected, the ECU 10 proceeds to step S150. When such an opposite-direction object OJ_{B} is not detected (No), that is, when only the traveling-direction object OJ_{A} is detected, the ECU 10 proceeds to step S160, executes notification processing targeting the traveling-direction object OJ_{A}, and then returns from the routine.

In step S150, the ECU 10 determines whether a degree of risk of the opposite-direction object OJ_{B} is higher than a degree of risk of the traveling-direction object OJ_{A}. When the degree of risk of the opposite-direction object OJ_{B} is not higher than that of the traveling-direction object OJ_{A} (No), the ECU 10 proceeds to step S160. When the degree of risk of the opposite-direction object OJ_{B} is higher than that of the traveling-direction object OJ_{A} (Yes), the ECU 10 proceeds to step S170.

In step S160, the ECU 10 executes notification processing targeting the traveling-direction object OJ_{A} and then returns from the routine. In step S170, the ECU 10 executes notification processing targeting the opposite-direction object OJ_{B} with priority and then returns from the routine.

Although the notification apparatus and the notification method according to the present embodiment have been described above, the present disclosure is not limited to the above-described embodiment, and various modifications may be made without departing from the spirit and scope of the present disclosure. For example, when both the traveling-direction object OJ_{A} and the opposite-direction object OJ_{B} are detected while the vehicle VH is traveling, the priority determination processing described above may be executed only when a degree of risk of the traveling-direction object OJ_{A} or the opposite-direction object OJ_{B} detected at a later timing is equal to or greater than a predetermined level. In addition, the technique of the present disclosure may also be applied to an automated driving vehicle in which some or all of driving operations are automatically performed. In such a case, the technique of the present disclosure may be activated when a driving mode is switched from automated driving to manual driving.

What is claimed is:

1. A notification apparatus comprising:
a front object detection unit configured to detect a front object present within a predetermined range in front of an own vehicle;
a rear object detection unit configured to detect a rear object present within a predetermined range behind the own vehicle;
a lateral object detection unit configured to detect a lateral object present within predetermined ranges on left and right sides of the own vehicle; and
a control unit configured to execute notification processing for notifying a warning to an occupant of the own vehicle when an object detected by at least one of the front object detection unit, the rear object detection unit, and the lateral object detection unit satisfies a predetermined notification condition,
wherein the control unit is configured to:
set a predetermined region in a traveling direction of the own vehicle as a traveling-direction region and set a predetermined region other than the traveling-direction region around the own vehicle as an opposite-direction region;
when the traveling direction is forward, treat the front object detected by the front object detection unit as a traveling-direction object present in the traveling-direction region, and treat the rear object detected by the rear object detection unit and the lateral object detected by the lateral object detection unit as opposite-direction objects present in the opposite-direction region;
when the traveling direction is rearward, treat the rear object detected by the rear object detection unit as a traveling-direction object present in the traveling-direction region, and treat the front object detected by the front object detection unit and the lateral object detected by the lateral object detection unit as opposite-direction objects present in the opposite-direction region; and
when a specific condition in which both the traveling-direction object and the opposite-direction object are detected while the own vehicle is traveling is satisfied, set a priority based on a relative positional relationship between the traveling-direction object and the opposite-direction object with respect to the own vehicle and execute the notification processing targeting either the traveling-direction object or the opposite-direction object in accordance with the set priority.

2. The notification apparatus according to claim 1,
wherein, when the specific condition is satisfied,
the control unit prioritizes notification processing targeting the opposite-direction object when the opposite-direction object is detected at a later timing than the traveling-direction object and a relative distance between the own vehicle and the opposite-direction object is less than or equal to a relative distance between the own vehicle and the traveling-direction object, and
prioritizes notification processing targeting the traveling-direction object when the traveling-direction object is detected at a later timing than the opposite-direction object and a relative distance between the own vehicle and the traveling-direction object is less than or equal to a relative distance between the own vehicle and the opposite-direction object.

3. The notification apparatus according to claim 1,
wherein the control unit is configured such that:
when a first traveling-direction object is detected and then a second traveling-direction object is detected, and a relative distance between the own vehicle and the second traveling-direction object is greater than a relative distance between the own vehicle and the first traveling-direction object, notification processing targeting the first traveling-direction object is continued without prioritizing the second traveling-direction object; and
when a first opposite-direction object is detected and then a second opposite-direction object is detected, and a relative distance between the own vehicle and the second opposite-direction object is greater than a relative distance between the own vehicle and the first opposite-direction object, notification processing targeting the first opposite-direction object is continued without prioritizing the second opposite-direction object.

4. The notification apparatus according to claim 1,
wherein the control unit recognizes the traveling direction as forward when a shift position of a transmission of the own vehicle is Drive, and recognizes the traveling direction as rearward when the shift position is Reverse.

5. A notification method comprising:
detecting at least one of a front object present within a predetermined range in front of an own vehicle, a rear object present within a predetermined range behind the own vehicle, and a lateral object present within predetermined ranges on left and right sides of the own vehicle;
executing notification processing for notifying a warning to an occupant of the own vehicle when a detected object satisfies a predetermined notification condition;
setting a predetermined region in a traveling direction of the own vehicle as a traveling-direction region and setting a predetermined region other than the traveling-direction region around the own vehicle as an opposite-direction region;
when the traveling direction is forward, treating the detected front object as a traveling-direction object present in the traveling-direction region and treating the detected rear object and the detected lateral object as opposite-direction objects present in the opposite-direction region;
when the traveling direction is rearward, treating the detected rear object as a traveling-direction object present in the traveling-direction region and treating the detected front object and the detected lateral object as opposite-direction objects present in the opposite-direction region; and
when both the traveling-direction object and the opposite-direction object are detected while the own vehicle is traveling, setting a priority based on a relative positional relationship between the traveling-direction object and the opposite-direction object with respect to the own vehicle and executing the notification processing targeting either the traveling-direction object or the opposite-direction object in accordance with the set priority.
